(19) United States
(12) Patent Application Publication
(10) Pub. No.: US 2026/0349908 A1
(43) Pub. Date: Nov. 5, 2026

(54) METHOD AND SYSTEM FOR MANAGING SOFTWARE TESTING USING SMART CONTRACTS DEPLOYED IN A BLOCKCHAIN NETWORK

(71) Applicant: Gopinath Kathiresan, Sunnyvale, CA (US)

(72) Inventor: Gopinath Kathiresan, Sunnyvale, CA (US)

(21) Appl. No.: 19/194,065

(22) Filed: Apr. 30, 2025

(51) Int. Cl. G06F 11/3668; G06F 8/77

(52) U.S. Cl. CPC G06F 11/3688; G06F 8/77

(57) ABSTRACT

A method and a system for managing software testing using smart contracts deployed in a blockchain network is disclosed. A processor receives test data associated with execution of a software test case. The test data is analysed to determine a corresponding test result. A software defect is identified based on the test result indicating an error condition. A smart contract stored on the blockchain network is executed to notify a developer associated with the software test case of the identified software defect. The test data and the corresponding test result is stored in a distributed ledger of the blockchain network.

### TECHNICAL FIELD

This disclosure relates generally to the field of, and more specifically to a method and system for managing software testing using smart contracts deployed in a blockchain network.

### BACKGROUND

In modern software lifecycles, testing is a critical phase used to verify that software applications function correctly, meet user requirements, and perform reliably under different conditions. Software testing involves executing codes, capturing results, and analyzing outcomes to detect defects, measure quality, and ensure compliance with functional and performance standards. Large-scale software projects typically require extensive testing workflows, which include assigning test tasks to appropriate testers, tracking progress, and managing test data.

Traditionally, the management of software testing relies on centralized systems and manual coordination between testers, developers, and project managers. Test results are often stored in local databases or project-specific platforms, and defect notifications are manually sent to developers via emails or ticketing systems. These practices are time-consuming, prone to human error, and lack transparency or verifiable audit trails. Additionally, testing data and decisions-such as who performed a test, what test data was used, or when a defect was reported can be altered or lost due to improper access control or lack of tamper-proof recordkeeping.

These challenges are further magnified in distributed development environments where testers and developers may be located in different geographic regions and where regulatory or organizational requirements mandate traceability, accountability, and secure audit logging. IN such scenarios, existing testing management tools may often fail short in ensuring objective reporting, enforcing deadlines, or preventing unauthorized data modifications.

Therefore, there is a need of a method for managing software testing using smart contracts deployed in a blockchain network. Such a method ensures secure, verifiable, and automated coordination between test participants while reducing reliance on manual processes. The method should allow for immutable storage of test data and outcomes, enforce rule-based logic to notify stakeholders in real-time, and provide a transparent, decentralized audit trail of all testing activities without relying on a central authority.

### SUMMARY OF THE INVENTION

In an embodiment, a method for managing software testing using smart contracts deployed in a blockchain network is disclosed. The method may include receiving, by a processor, test data associated with execution of a software test case. The method may further include analysing, by the processor, the test data to determine a corresponding test result. In an embodiment, the test result may include at least one of a successful execution indicator or an error message associated with the software test case. The method may further include identifying, by the processor, a software defect based on the test result indicating an error condition. The method may further include executing, by the processor, a smart contract stored on the blockchain network to notify a developer associated with the software test case of the identified software defect. The method may further include storing, by the processor, the test data and the corresponding test result in a distributed ledger of the blockchain network.

In accordance with the embodiment, the method may further include assigning, by the processor, the software test case to a tester based on tester profile data stored in the blockchain network. In an embodiment, the tester profile data may include at least a job level and a technical specialization.

In accordance with the embodiment, the method may further include evaluating, by the processor, a progress status of the software test case based on historical test execution records stored on the blockchain network. The method may further include executing, by the processor, a smart contract to issue a reminder to the assigned tester when a predefined completion deadline is approaching.

In accordance with the embodiment, the method may further include determining, by the processor, a quality score of the completed software test case using one or more predefined evaluation metrics. In an embodiment, the predefined metrics may include at least one of function coverage, execution latency, error frequency, and stability index.

In accordance with the embodiment, the method may further include authenticating, by the processor, a user based on a cryptographic key associated with the user stored in the blockchain network. The method may further include authorizing, by the processor, the authenticated user to modify access control parameters associated with selected test-related data entries.

In another embodiment, a system for managing software testing using smart contracts deployed in a blockchain network is disclosed. The system may include a processor, and a memory communicatively coupled to the processor and storing computer-executable instructions that, when executed by the processor, cause the processor to receive test data associated with execution of a software test case. The processor may further analyse the test data to determine a corresponding test result. In an embodiment, the test result may include at least one of a successful execution indicator or an error message associated with the software test case. The processor may further identify a software detect based on the test result indicating an error condition. The processor may further execute a smart contract stored on the blockchain network to notify a developer associated with the software test case of the identified software defect. The processor may further store the test data and the corresponding test result in a distributed ledger of the blockchain network.

In accordance with the embodiment, the computer-executable instructions may further cause the processor to assign the software test case to a tester based on tester profile data stored in the blockchain network. In an embodiment, the tester profile data may include at least a job level and a technical specialization.

In accordance with the embodiment, the computer-executable instructions may further cause the processor to evaluate a progress status of the software test case based on historical test execution records stored on the blockchain network. The processor may further execute a smart contract to issue a reminder to the assigned tester when a predefined completion deadline is approaching.

In accordance with the embodiment, the computer-executable instructions may further cause the processor to determine a quality score of the completed software test case using one or more predefined evaluation metrics. In an embodiment, the predefined metrics may include at least one of: function coverage, execution latency, error frequency, and stability index.

In accordance with the embodiment, the computer-executable instructions may further cause the processor to authenticate a user based on a cryptographic key associated with the user stored in the block chain network. The processor may further authorize the authenticated user to modify access control parameters associated with selected test-related data entries.

In yet another embodiment, a non-transitory computer-readable medium storing computer-executable instructions for managing software testing using smart contracts deployed in a blockchain network is disclosed. The computer-executable instructions configured for receiving test data associated with execution of a software test case. The computer-executable instructions further configured for analysing the test data to determine a corresponding test result. In an embodiment, the test result may include at least one of a successful execution indicator or an error message associated with the software test case. The computer-executable instructions further configured for identifying a software defect based on the test result indicating an error condition. The computer-executable instructions further configured for executing a smart contract stored on the blockchain network to notify a developer associated with the software test case of the identified software defect. The computer-executable instructions further configured for storing the test data and the corresponding test result in a distributed ledger of the blockchain network.

In accordance with the embodiment, the computer-executable instructions further configured for assigning the software test case to a tester based on tester profile data stored in the blockchain network. In an embodiment, the tester profile data may include at least a job level and a technical specialization.

In accordance with the embodiment, the computer-executable instructions further configured for evaluating a progress status of the software test case based on historical test execution records stored on the blockchain network. The computer-executable instructions further configured for executing a smart contract to issue a reminder to the assigned tester when a predefined completion deadline is approaching.

In accordance with the embodiment, the computer-executable instructions further configured for determining a quality score of the completed software test case using one or more predefined evaluation metrics. In an embodiment, the predefined metrics may include at least one of function coverage, execution latency, error frequency, and stability index.

In accordance with the embodiment, the computer-executable instructions further configured for authenticating a user based on a cryptographic key associated with the user stored in the blockchain network. The computer-executable instructions further configured for authorizing the authenticated user to modify access control parameters associated with selected test-related data entries.

It is to be understood that both the foregoing general description and the following detailed description are exemplary and explanatory only and are not restrictive of the invention, as claimed.

### OBJECTIVES OF THE INVENTION

An objective of the present invention is to provide a computer-implemented method and system for managing software testing using smart contracts deployed in a blockchain network, thereby addressing the limitations of traditional test management systems. The invention seeks to enable automated, secure, and tamper-resistant recording of test data and test results, while facilitating real-time notifications to developers upon the detection of software defects. By leveraging smart contracts, the invention allows for rule-based task coordination, tester authentication, deadline tracking, and quality evaluation without manual intervention, ensuring increased objectivity, auditability, and reliability in decentralized or distributed software development environments.

In the context of this specification, terms like the following shall have the meanings provided below, unless otherwise specified or required by context. These definitions are intended to assist a person skilled in the art in understanding the structure, function, and implementation of the disclosed invention.

The term “test data” refers to input data used to execute a software test case. This may include valid inputs, invalid inputs, edge-case parameters, or preconfigured scripts designed to trigger specific functions or behaviours within the software under test.

The term “software test case” refers to a discrete unit of testing designed to evaluate a specific feature, function, or behaviour of a software application. A test case typically includes input conditions, execution steps, expected outcomes, and evaluation criteria.

The term “test result” refers to the outcome obtained from executing a software test case using corresponding test data. The result may include an indication of successful execution, error messages, exceptions, logs, return values, or any measurable behaviour that reflects how the software responded to the test data.

The term “software defect” refers to an error, flaw, or unintended behaviour in the software, typically evidenced by the test result deviating from the expected outcome. A defect may include runtime failures, logic errors, crashes, or functional misbehaviour.

The term “smart contract” refers to a software-encoded, self-executing logic structure deployed on a blockchain network that autonomously enforces predefined conditions and actions. In the context of the present invention, smart contracts are used to automate tasks such as defect notifications, test reminders, and access control enforcement.

The term “blockchain network” refers to a distributed computing infrastructure in which data is stored in blocks linked using cryptographic hashes. The blockchain network may include multiple nodes that participate in transaction validation, consensus, and data propagation. In this invention, the blockchain serves as an immutable ledger for test records, task assignments, and execution logs.

The term “developer” refers to an individual or agent responsible for writing, maintaining, or correcting source code within the software under test. Developers may be notified via smart contract logic upon detection of defects related to their assigned components.

The term “tester” refers to an individual or automated agent tasked with executing software test cases and validating software behaviour. The tester interacts with the system through a test client and may be represented on the blockchain via a unique node or identifier.

The term “tester profile data” refers to information associated with a tester, including but not limited to job level, technical specialization, certification status, experience domain, or past test performance, and may be stored immutably within the blockchain network.

The term “test case assignment” refers to the automated or manual allocation of a software test case to a particular tester, based on matching the tester profile data with the test case's characteristics such as domain, complexity, or priority.

The term “progress status” refers to a temporal and performance-based measure of how far a test case or group of test cases has progressed toward completion. It may include execution timestamps, attempt counts, pass/fail indicators, and deadline adherence.

The term “quality score” refers to a computed metric indicating the reliability, completeness, or performance of a software test case or its result. It may be derived from predefined evaluation metrics such as functional coverage, execution latency, error frequency, and stability index.

The term “cryptographic key” refers to a unique digital signature or cryptographic identifier associated with a user, node, or agent within the blockchain network. It is used to verify identity, enforce access control, and sign transactions securely.

The term “access control parameters” refers to a set of rules or permissions governing which users or agents can read, write, modify, or delete certain data entries within the test management system. These parameters may be defined and enforced through smart contracts on the blockchain.

The term “distributed ledger” refers to a replicated and synchronized data structure maintained across multiple blockchain nodes, ensuring tamper-evident and verifiable records of all test-related activities, results, and interactions.

### BRIEF DESCRIPTION OF THE DRAWING

The accompanying drawings, which are incorporated in and constitute a part of the present disclosure, illustrate exemplary embodiments of the invention and, together with the detailed description, serve to explain the principles of the invention without limiting its scope.

FIG. 1 is a block diagram of an exemplary system for managing software testing using smart contracts deployed in a blockchain network, in accordance with an embodiment of the present disclosure.

FIG. 2 is a flowchart illustrating an exemplary computer-implemented method for managing software testing using smart contracts deployed in a blockchain network, in accordance with an embodiment of the present disclosure.

FIG. 3 is a flowchart illustrating an exemplary method for assigning a software test case to a tester based on tester profile data stored in the blockchain network, in accordance with an embodiment of the present disclosure.

FIG. 4 is a flowchart illustrating an exemplary method for evaluating the progress of a software test case based on historical test execution records stored in a blockchain network, in accordance with an embodiment of the present disclosure.

FIG. 5 is a flowchart illustrating an exemplary method for determining a quality score of a completed software test case using predefined evaluation metrics, in accordance with an embodiment of the present disclosure.

FIG. 6 is a schematic diagram illustrating the interaction between a test client, a blockchain node, a smart contract object, and a developer node, in accordance with an embodiment of the present disclosure.

FIG. 7 is a schematic diagram illustrating a method for authenticating a user and controlling access to test-related data using a cryptographic key and blockchain-based identity mapping, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered exemplary only, with the true scope being indicated by the following claims. Additional illustrative embodiments are listed.

Further, the phrases “in some embodiments”, “in accordance with some embodiments”, “in the embodiments shown”, “in other embodiments”, and the like mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope being indicated by the following claims.

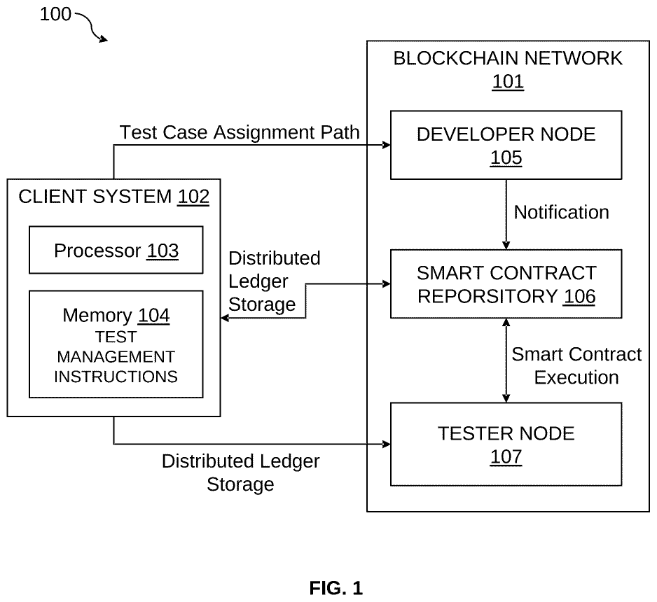

Referring now to FIG. 1, a block diagram of an exemplary system 100 for managing software testing using smart contracts deployed in a blockchain network 101, is illustrated, in accordance with an embodiment of the present disclosure. The system 100 may include a client system 102 communicatively coupled to a blockchain network 101. The client system 102 and the blockchain network 101 may exchange information over a network that may include, but is not limited to, a public or private communication network, such as the Internet, a peer-to-peer (P2P) network, a virtual private network (VPN), or any combination thereof.

The client system 102 may include one or more computing devices, such as a server, personal computer, laptop, workstation, or virtual machine. The client system 102 may include a processor 103 operatively coupled to a memory 104. The processor 103 may be configured to execute instructions stored in the memory 104. The memory 104 may store computer-executable instructions, including but not limited to, software routines, logic, or applications used to manage data exchange with the blockchain network 101. In some embodiments, the memory 104 may also include persistent storage, cache, or non-transitory computer-readable media.

The blockchain network 101 may represent a decentralized or distributed ledger infrastructure that maintains replicated, immutable records of digital transactions. The blockchain network 101 may include a plurality of interconnected nodes, which may include at least a developer node 105, a smart contract repository 106, and a tester node 107. Each node may include a blockchain client instance, local storage, and logic for consensus participation, smart contract execution, or data validation.

The developer node 105 may be associated with one or more users or agents responsible for software-related functions. The smart contract repository 106 may store one or more smart contract instances that are accessible for execution within the blockchain network 101. The tester node 107 may be associated with users or entities responsible for initiating and validating testing operations. Each of the nodes within the blockchain network 101 may participate in data propagation, block validation, or execution of logic defined by stored smart contracts.

In some embodiments, communication paths may be established between the client system 102 and the blockchain network 101 to enable data exchange. As illustrated in FIG. 1, the system 100 may include logical paths labelled as “Test Case Assignment Path,” “Distributed Ledger Storage,” “Notification,” and “Smart Contract Execution,” each representing a directional data flow or event trigger between components of the client system 101 and corresponding nodes in the blockchain network 101.

The components illustrated in FIG. 1 are shown by way of example and not limitation. Additional components or alternative architectural arrangements may be utilized in other embodiments consistent with the objectives of maintaining communication between a client system and a blockchain network.

By way of an example, the client system 102 may receive test data associated with the execution of a software test case. This test data may include input parameters, expected outcomes, and other relevant information necessary for executing the test case. The processor 103 within the client system 102 may analyse the received test data to determine a corresponding test result, which may include at least one of a successful execution indicator or an error message associated with the software test case.

Upon determining the test result, the processor 103 may identify a software defect based on the test result indicating an error condition. In response to identifying the software defect, the processor 103 may execute a smart contract stored on the blockchain network 101 to notify a developer associated with the software test case of the identified software defect. The smart contract may facilitate automated notifications and logging of the defect information.

Subsequently, the processor 103 may store the test data and the corresponding test result in a distributed ledger of the blockchain network 101. In some embodiments, the processor 103 may assign the software test case to a tester based on tester profile data stored in the blockchain network 101. The tester profile may include at least a job level and a technical specification to allow appropriate matching of test cases to testers with suitable expertise.

Further, the processor 103 may evaluate a progress status of the software test case based on historical test execution records stored on the blockchain network 101. If a predefined completion deadline is approaching, the processor 103 may execute a smart contract to issue a reminder to the assigned tester to facilitate timely completion of testing tasks.

Upon completion of the software test case, the processor 103 may determine a quality score using one or more predefined evaluation metrics, wherein the predefined metrics may include at least one of function coverage, execution latency, error frequency, and stability index. This quality score may be stored in the blockchain network 101 for future reference and analysis. Additionally, the processor 103 may authenticate a user based on a cryptographic key associated with the user stored in the blockchain network 101. Upon successful authentication, the processor 103 may authorize the authenticated user to modify access control parameters associated with selected test-related data entries to ensure secure and controlled access to sensitive testing information.

By way of example, consider a scenario where a software development team is utilizing the system 100 for managing software testing processes. The client system 102 receives test data associated with the execution of a software test case. This test data includes input parameters, expected outcomes, and other relevant information necessary for executing the test case. The processor 103 within the client system 102 analyses the received test data to determine a corresponding test result, which may include a successful execution indicator, or an error message associated with the software test case.

Upon determining the test result, the processor 103 identifies a software defect based on the test result indicating an error condition. In response to identifying the software defect, the processor 103 executes a smart contract stored on the blockchain network 101 to notify a developer associated with the software test case of the identified software defect. The smart contract facilitates automated notifications and logging of the defect information. Subsequently, the processor 103 stores the test data and the corresponding test result in a distributed ledger of the blockchain network 101, thereby ensuring an immutable and transparent record of the testing activities.

In some embodiments, the processor 103 assigns the software test case to a tester based on tester profile data stored in the blockchain network 101. The tester profile data includes at least a job level and a technical specialization, allowing for appropriate matching of test cases to testers with suitable expertise. Further, the processor 103 evaluates a progress status of the software test case based on historical test execution records stored on the blockchain network 101. If a predefined completion deadline is approaching, the processor 103 executes a smart contract to issue a reminder to the assigned tester, thereby facilitating timely completion of testing tasks. Upon completion of the software test case, the processor 103 determines a quality score using one or more predefined evaluation metrics, wherein the predefined metrics include at least one of function coverage, execution latency, error frequency, and stability index. This quality score is stored in the blockchain network 101 for future reference and analysis.

Additionally, the processor 103 authenticates a user based on a cryptographic key associated with the user stored in the blockchain network 101. Upon successful authentication, the processor 103 authorizes the authenticated user to modify access control parameters associated with selected test-related data entries, ensuring secure and controlled access to sensitive testing information.

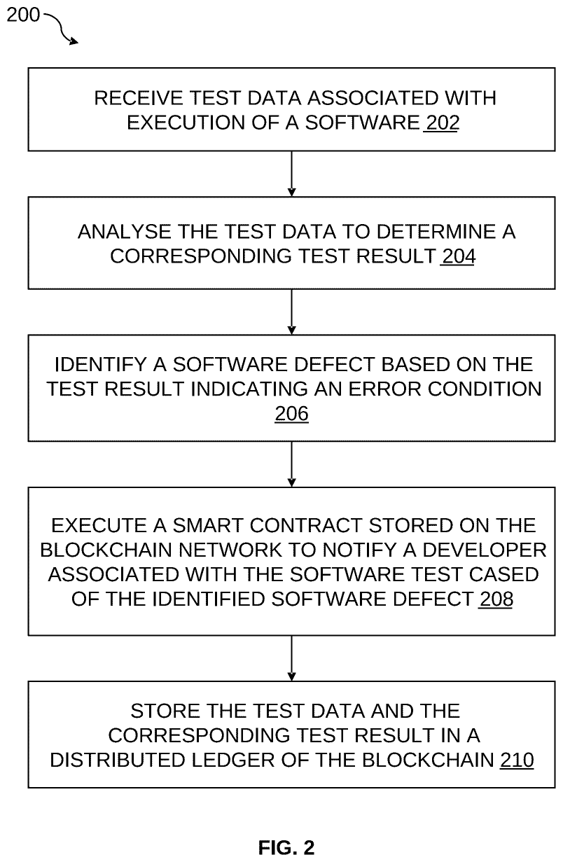

Referring now to FIG. 2, a flowchart 200 illustrating an exemplary computer-implemented method for managing software testing using smart contracts deployed in the blockchain network 101, is illustrated, in accordance with an embodiment of the present disclosure. The method 200 may be executed by the processor 103 of the client system 102, configured to interact with one or more components of the blockchain network 101 including a developer node 105, a tester node 107, and a smart contract repository 106, as previously described with reference to FIG. 1.

At step 202, the processor 103 receives test data associated with the execution of a software test case. The test data may include one or more input parameters, execution scripts, boundary values, or configuration settings provided by a tester or an automated test framework. The software test case may be pre-defined and associated with a specific software module, feature, or user requirement.

Further at step 204, the processor 103 analyses the received test data to determine a corresponding test result. The test result may include various outputs or indicators reflecting the behaviour of the software in response to the test inputs. In some cases, the test result may include a success message, functional logs, or execution metrics. In other cases, it may include an error message, crash log, or deviation from expected outcomes, indicating abnormal behaviour.

Further at step 206, the processor 103 may identify a software defect based on the test result indicating an error condition. The error condition may be determined by comparing the observed output with the expected output, detecting exception traces, or identifying threshold violations in performance metrics. The defect may relate to logic flows, interface misbehaviour, incomplete functionality, or unhandled scenarios.

Further at step 208, in response to detecting the defect, the processor 103 may execute a smart contract stored on the blockchain network 101 to notify a developer associated with the software test case. The smart contract may contain logic that maps software modules or test case identifiers to specific developer accounts or nodes and automatically triggers a notification event. The notification may be logged on-chain and sent to the developer node 105 through a verified blockchain transaction. Further at step 210, the processor 103 may store the test data and the corresponding test result in a distributed ledger of the blockchain network 101.

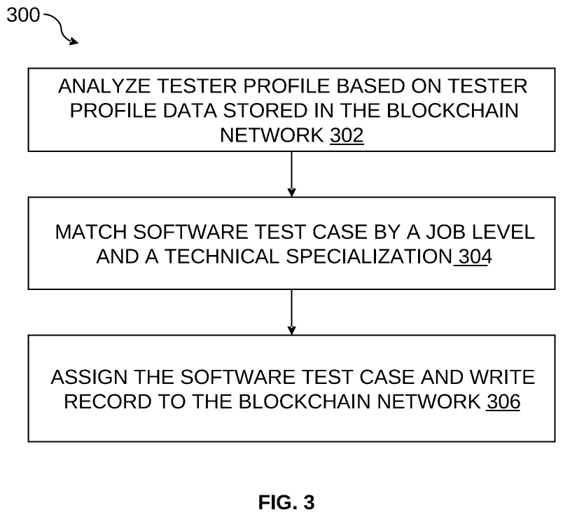

Referring now to FIG. 3, a flowchart 300 illustrating an exemplary method for assigning a software test case to a tester based on tester profile data stored in the blockchain network 101, is illustrated, in accordance with an embodiment of the present disclosure. The method may be performed by the processor 103 of the client system 102, which is configured to interact with the blockchain network 101 for accessing and storing test-related data.

At step 302, the processor 103 may analyse the tester profile based on tester profile data stored in the blockchain network 101. The tester profile data may include attributes such as job level, area of technical specialization, historical test performance, certification status, or previous assignments. This information may be recoded or verified on the blockchain network 101 to ensure authenticity and immutability.

Further at step 304, the processor 103 may match a software test case to a tester using at least two matching criteria: a job level and a technical specialization. The job level may reflect the seniority, permission scope, or authority level of the tester, while the technical specialization may include domain knowledge in areas such as UI testing, API testing, backend systems, security testing, or performance benchmarking. The matching process may involve rule-based logic or smart contract-enabled decision criteria.

Further at step 306, the processor 103 may assign the software test case to the selected tester and writes a corresponding assignment record to the blockchain network 101. The record may include identifiers for the test case, the tester, and the timestamp of the assignment event. Storing this record in the distributed ledger ensures traceability and enables future reference during progress tracking, auditing, quality evaluation processes.

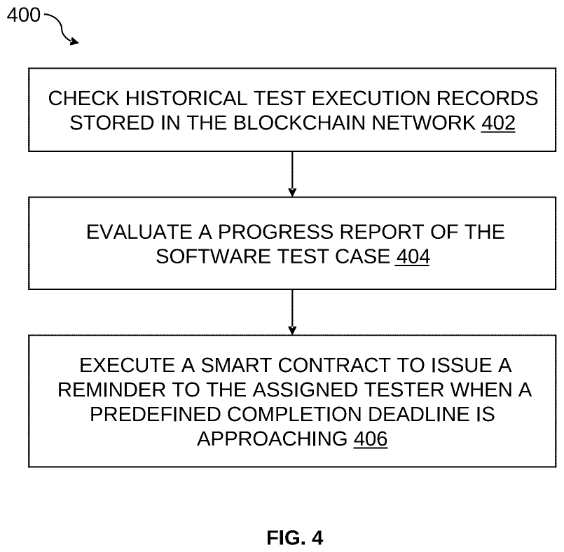

Referring now to FIG. 4, a block diagram 400 illustrating an exemplary method for determining a quality score of a completed software test case using predefined evaluation metrics, is illustrated, in accordance with an embodiment of the present disclosure. The method may be executed by the processor 103 of the client system 102 as part of an automated test workflow that may include scheduling and monitoring of the completion status of assigned test cases.

At step 402, the processor 103 may check historical test execution records stored in the blockchain network 101. These records may include timestamps, test identifiers, tester IDs, pass/fail outcomes, and version histories that were previously written to the distributed ledger as part of earliest test executions. The immutability of blockchain records ensures data authenticity and traceability.

At step 404, the processor 103 evaluates a progress report of the software test case. This evaluation may be based on one or more indicators such as the number of times a test case has been executed, whether all required test scenarios have been covered, or whether the tester has completed test validation within an expected timeframe. In some embodiments, predefined thresholds or logic-based rules may be used to assess whether the software test case is on track for timely completion.

Further at step 406, when the processor 103 may determine that a predefined completion deadline is approaching and the assigned test case remains incomplete, the processor 103 may execute a smart contract stored on the blockchain network 101 to issue a reminder notification to the assigned tester. The smart contract may be configured to automatically dispatch the reminder to the tester node 107 or another blockchain address associated with the tester profile. The issuance of the reminder may also be logged on-chain for auditability.

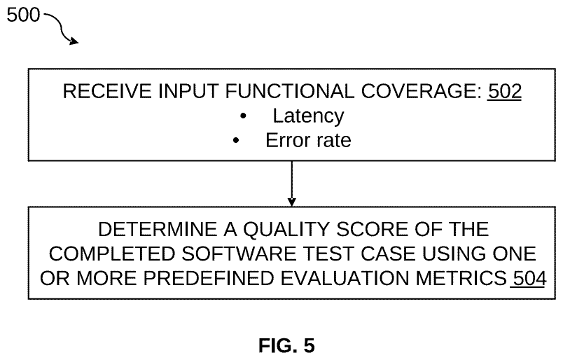

Referring now to FIG. 5, a flowchart 500 illustrating an exemplary method for determining a quality score of a completed software test case using predefined evaluation metrics, is illustrated, in accordance with an embodiment of the present disclosure. The method may be executed by the processor 103 of the client system 102 following the completion of test execution and may be configured to generate an objective measurement of software test effectiveness.

At step 502, the processor 103 received input values corresponding to one or more evaluation metrics derived from the test result. These metrics may include, but are not limited to, functional coverage, latency, and error rate. In an embodiment, the functional coverage may indicate the extent to which the software code paths, branches or components have been exercised by the executed test case. In an embodiment, the latency may indicate the time interval between the initiation and completion of the software test case or a specific function under test. In an embodiment, the error rate may include the frequency of error conditions encountered during test execution, including both fatal and non-fatal errors. These input metrics may be automatically generated during test execution and may be stored either locally or in the blockchain network 101 along with the test result.

Further at step 504, the processor 103 may determine a quality score of the completed software test case using one or more of the received metrics. The quality score may be computed based on a predefined scoring model, such as a weighted average, a normalization formula, or a rule-based evaluation framework. The use of structured and predefined metrics ensures standardization across test evaluations and supports objective decision-making regarding the effectiveness, completeness, and reliability of the test case. In some embodiments, the computed quality score may be stored in the distributed ledger of the blockchain network 101 to enable immutable and auditable tracking of quality performance over time. The quality score may also be used to support downstream processes such as regression testing, performance benchmarking, or test plan refinement.

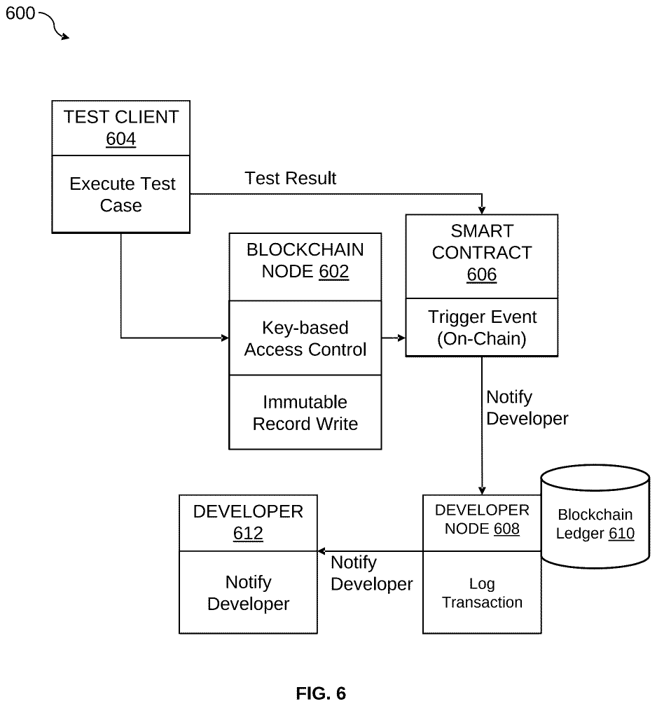

Referring now to FIG. 6, a schematic diagram 600 illustrating the interaction between a test client 604, a blockchain node 602, a smart contract object 606 and a developer node 608, is illustrated, in accordance with an embodiment of the present disclosure. FIG. 6 form an operational instance of the system 100 previously shown in FIG. 1, where software testing data is processed, validated, and logged using blockchain-enabled mechanisms.

The test client 604 may be a local or remote interface operated by a tester or an automated testing agent. The test client 604 may be configured to execute software test cases and generate corresponding test results. These results may include success or failure indicators, performance metrics, and error logs. The test result may be transmitted from the test client 604 to the blockchain node 602 and may also directly to the smart contract 606 for evaluation and processing.

The blockchain node 602 may correspond to the tester node 107 or another participant node within the blockchain network 101 of FIG. 1. This node performs key-based access control, verifying via cryptographic keys prior to accepting and processing data. The blockchain node 602 may be further responsible for performing immutable record writes, i.e., logging the received test result and associated metadata into the blockchain ledger 610.

The smart contract 606, stored on-chain and accessible to blockchain nodes, is configured to trigger an event when a defect condition is identified in the test result. This event may include logic to associate a specific software component or test case with a corresponding developer node 608. Upon triggering, the smart contract 606 may generate an on-chain transaction that may be propagated to the developer node 608, which then logs the transaction and notifies the developer.

The developer node 608 may be a blockchain participant corresponding to the developer node 105 of FIG. 1. It is responsible for receiving and processing notifications about identifies defects. The developer node 608 may also be linked to a registered developer identity 612, who is alerted through the notification path. A separate instance of developer identity 612 may be illustrated to indicate notification delivery through various mechanisms (e.g., email, system alert, API callback), depending on the implementation.

The blockchain ledger 610 may be a replicated and distributed data store accessible by all authorized nodes within the blockchain network 101. The blockchain ledger 610 may ensure tamper-proof storage of all testing, execution, and notification events. The process begins when the test client 604 may execute a software test case generates test data, which includes input parameters and execution conditions. The test result whether indicating successful execution or an error message may be transmitted to the blockchain node 602 and the smart contract 606. The blockchain node 602, representing an instance of the tester node 107 in FIG. 1, verifies the integrity of the submission through key-based access control, ensuring that only authorized entities contribute data.

The test result may be then analysed to determine whether a software defect exists. If the test result indicates an error condition, the smart contract 606 may be triggered. The smart contract 606 executes a rule-based operation to determine the responsible developer and initiates a notification by sending a blockchain transaction to the corresponding developer node 608. The developer node 608 may represent a participant node such as developer node 105 in FIG. 1, logs this event to the blockchain ledger 610 and alerts the developer 612. Following this, the blockchain node 602 stores the test data and the corresponding test result immutably in the blockchain ledger 610.

Further, the test client or blockchain node may perform a test case assignment prior to execution, based on tester profile data that may include job level and technical specialization. This assignment process may be facilitated by earlier smart contract evaluations or lookup tables stored on-chain.

The blockchain node 602 may access historical test execution records to compute a progress status for ongoing or incomplete test cases. When a predefined deadline is detected to be approaching, the smart contract 606 may be triggered again to issue a reminder to the responsible tester node, which may in turn notify the appropriate test client instance for follow-up.

Once the software test case is completed, the processor 103 may compute a quality score based on an input metrics such as function coverage, latency, error frequency, and stability index. Data which may be submitted via the test client 604 and analyzed by the processor 103 or the smart contract logic prior to storage in the blockchain ledger 610. Finally, user authentication is enforced by the blockchain node 602 via cryptographic key-based identity verification. When a user attempts to modify access control parameters associated with test-related data, the node verifies the key and grants or denies permission based on role definitions stored in the blockchain network 101.

By way of an example, consider a distributed software development team using the disclosed system to manage functional testing of a web-based payroll module. A tester named Alice logs into the test client 604, a user interface connected to the client system 102 and is assigned a software test case that verifies the correct calculation of tax deductions. The processor 103 may first perform a test case by analysing Alice's tester profile data stored in the blockchain network 101. Alice's profile includes a job level of “Senior QA” and a technical specialization in backend logic verification. A smart contract determines that Alice is appropriately qualified and assigns her the payroll test case, recording the assignment in the blockchain ledger.

Alice runs the test case using the test client 604, which generates test data specifically, input salary values and expected deduction outputs. This test data is transmitted to the blockchain node 602, where it is recorded as part of the software test case execution. The processor 103 then analyses the test data to determine a test result. In this case, the test result reveals an error condition, the tax is calculated incorrectly for salaries above a certain threshold, indicating a software defect.

This triggers execution of a smart contract 606, which is preconfigured to notify the appropriate developer. The contract maps the test case to a developer node 608, operated by a developer name Ravi, who originally wrote the payroll logic. The smart contract sends a notification transaction to Ravi's developer node and logs the defect in the blockchain ledger 610. As Alice continues to work through her assigned cases, the processor 103 may periodically evaluate her progress status by checking execution history recorded on the blockchain network 101. When a predefined deadline (e.g., 48 hours post-assignment) is approaching and some test cases remain incomplete, the smart contract triggers a reminder to Alice's test client, ensuring test milestone are met.

Once the test case is completed and resolved, the processor 103 may compute a quality score based on a set of predefined evaluation metrics. For this scenario, the test achieved 95% function coverage, an average execution latency of 800 ms, a low error frequency, and a high stability index across five environments. The quality score may be calculated and stored immutably on the blockchain for future audits and reporting.

Separately, a QA lead named Priya attempts to modify the access permissions of certain test case records. Before granting access, the blockchain node 602 performs user authentication by verifying Priya's cryptographic key. Once authenticated, Priya is permitted to modify access control parameters associated with a subset of sensitive data entries, such as test cases related to financial computation modules.

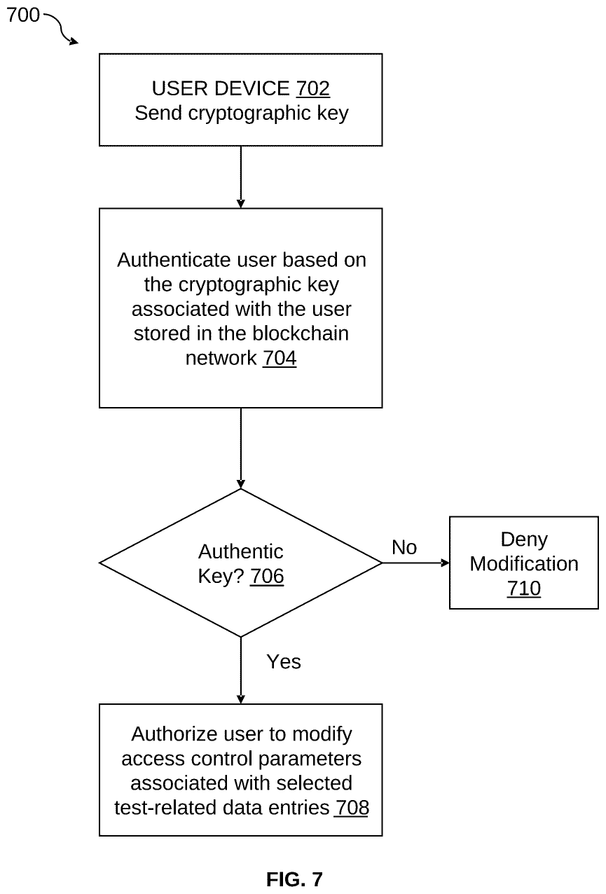

Referring now to FIG. 7, a schematic diagram 700 illustrating a method for authenticating a user and controlling access to test-related data using a cryptographic key and blockchain-based identity mapping, is illustrated, in accordance with an embodiment of the present disclosure. The method may be executed by the processor 103 of the client system 102 or by the blockchain node 602 as part of enforcing secure access policies for data stored within the blockchain network 101.

At step 702, a user device initiates a request to modify selected test-related data entries by transmitting a cryptographic key. The cryptographic key may be a digital signature, private key, or other secure identifier previously registered to the user's blockchain identity during system enrolment.

Further at step 704, the system 100 authenticates the user based on the cryptographic key associated with the user stored within the blockchain network 101. The authentication process involves verifying that the received cryptographic key matches a known entry recorded immutably in the blockchain ledger 610 or associated with the user's profile data. Further at step 706, the system 100 determines whether the cryptographic key is authentic. If the key verification fails (e.g., due to mismatch, expiration, or tampering), the method proceeds to step 710, where modification access is denied. A corresponding access denial event may be logged in the blockchain ledger for audit purposes.

If the key is successfully authenticated, the method proceeds to step 708, where the system 100 authorizes the user to modify access control parameters associated with selected test-related data entries. The modifications may include altering user permissions, granting or revoking access rights, or changing visibility settings for specific test results, assignments, or progress records.

Thus, the disclosed method 200 and system 100 overcome the challenges associated with conventional software testing management systems that rely on manual coordination, centralized databases, and unsecured communication workflows. By leveraging smart contracts deployed in the blockchain network 101, the invention enables decentralized and rule-based automation of test assignment, result evaluation, defect notification, and access control. The integration of cryptographically authenticated identities and immutable recordkeeping ensures enhanced objectivity, transparency, and security in distributed testing environments. As a result, the disclosed embodiments provide a robust technical solution that reduces reliance on manual tracking, mitigates the risk of data tampering, and facilitates auditable, real-time interaction among testers, developers, and quality managers.

As will be appreciated by those skilled in the art, the techniques described in the various embodiments discussed above are not routine, or conventional, or well-understood in the art. The techniques discussed above provide for managing software testing using smart contracts deployed in a blockchain network.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The specification has described the management of software testing using smart contracts deployed in a blockchain network. The illustrated steps are set out to explain the exemplary embodiments shown, and it should be anticipated that ongoing technological development will change the manner in which particular functions are performed. These examples are presented herein for the purpose of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

It is intended that the disclosure and examples be considered as exemplary only, with a true scope of disclosed embodiments being indicated by the following claims.

What is claimed is:

1. A computer-implemented method for managing software testing using smart contracts deployed in a blockchain network, the method comprising:
receiving, by a processor, test data associated with execution of a software test case;
analysing, by the processor, the test data to determine a corresponding test result,
wherein the test result comprises at least one of a successful execution indicator or an error message associated with the software test case;
identifying, by the processor, a software defect based on the test result indicating an error condition;
executing, by the processor, a smart contract stored on the blockchain network to notify a developer associated with the software test case of the identified software defect; and
storing, by the processor, the test data and the corresponding test result in a distributed ledger of the blockchain network.

2. The computer-implemented method of claim 1, further comprising:
assigning, by the processor, the software test case to a tester based on tester profile data stored in the blockchain network,
wherein the tester profile data comprises at least a job level and a technical specialization.

3. The computer-implemented method of claim 2, further comprising:
evaluating, by the processor, a progress status of the software test case based on historical test execution records stored on the blockchain network; and
executing, by the processor, a smart contract to issue a reminder to the assigned tester when a predefined completion deadline is approaching.

4. The computer-implemented method of claim 3, further comprising:
determining, by the processor, a quality score of the completed software test case using one or more predefined evaluation metrics,
wherein the predefined metrics comprising at least one of: function coverage, execution latency, error frequency, and stability index.

5. The computer-implemented method of claim 1, further comprising:
authenticating, by the processor, a user based on a cryptographic key associated with the user stored in the blockchain network; and
authorizing, by the processor, the authenticated user to modify access control parameters associated with selected test-related data entries.

6. A system for managing software testing using smart contracts deployed in a blockchain network, the system comprising:
a processor; and
a memory communicatively coupled to the processor and storing computer-executable instructions that, when executed by the processor, cause the processor to:
receive test data associated with execution of a software test case;
analyse the test data to determine a corresponding test result,
wherein the test result comprises at least one of a successful execution indicator or an error message associated with the software test case;
identify a software defect based on the test result indicating an error condition;
execute a smart contract stored on the blockchain network to notify a developer associated with the software test case of the identified software defect; and
store the test data and the corresponding test result in a distributed ledger of the blockchain network.

7. The system of claim 6, wherein the computer-executable instructions further cause the processor to:
assign the software test case to a tester based on tester profile data stored in the blockchain network,
wherein the tester profile data comprises at least a job level and a technical specialization.

8. The system of claim 7, wherein the computer-executable instructions further causse the processor to:
evaluate a progress status of the software test case based on historical test execution records stored on the blockchain network; and
execute a smart contract to issue a reminder to the assigned tester when a predefined completion deadline is approaching.

9. The system of claim 8, wherein the computer-executable instructions further cause the processor to:
determine a quality score of the completed software test case using one or more predefined evaluation metrics,
wherein the predefined metrics comprise at least one of: function coverage, execution latency, error frequency, and stability index.

10. The system of claim 6, wherein the computer-executable instructions further cause the processor to:
authenticate a user based on a cryptographic key associated with the user stored in the block chain network; and
authorize the authenticated user to modify access control parameters associated with selected test-related data entries.

11. A non-transitory computer-readable medium storing computer-executable instructions for managing software testing using smart contracts deployed in a blockchain network, the computer-executable instructions configured for:
receiving test data associated with execution of a software test case;
analysing the test data to determine a corresponding test result,
wherein the test result comprises at least one of a successful execution indicator or an error message associated with the software test case;
identifying a software defect based on the test result indicating an error condition;
executing a smart contract stored on the blockchain network to notify a developer associated with the software test case of the identified software defect; and
storing the test data and the corresponding test result in a distributed ledger of the blockchain network.

12. The non-transitory computer-readable medium of claim 11, wherein the computer-executable instructions are further configured for:
assigning the software test case to a tester based on tester profile data stored in the blockchain network,
wherein the tester profile data comprises at least a job level and a technical specialization.

13. The non-transitory computer-readable medium of claim 12, wherein the computer-executable instructions are further configured for:
evaluating a progress status of the software test case based on historical test execution records stored on the blockchain network; and
executing a smart contract to issue a reminder to the assigned tester when a predefined completion deadline is approaching.

14. The non-transitory computer-readable medium of claim 13, wherein the computer-executable instructions are further configured for:
determining a quality score of the completed software test case using one or more predefined evaluation metrics,
wherein the predefined metrics comprising at least one of: function coverage, execution latency, error frequency, and stability index.

15. The non-transitory computer-readable medium of claim 11, wherein the computer-executable instructions are further configured for:
authenticating a user based on a cryptographic key associated with the user stored in the blockchain network; and
authorizing the authenticated user to modify access control parameters associated with selected test-related data entries.
